(19) United States
(12) Patent Application Publication
(10) Pub. No.: US 2006/0083399 A1
(43) Pub. Date: Apr. 20, 2006

(54) Earphone connector assembly

(76) Inventor: Johnson Yang, Jhonghe City (TW)

Correspondence Address: CHARLES E. BAXLEY, ESQ., 90 JOHN STREET, THIRD FLOOR, NEW YORK, NY, 10038, US

(21) Appl. No.: 10/969,446

(22) Filed: Oct. 20, 2004

(51) Int. Cl. H04R 25/00

(52) U.S. Cl. 381/384; 381/374; 381/370

(57) ABSTRACT

The present invention relates to an earphone connector assembly which comprises: a connector, a cover and a plurality of independent terminals. The connector is provided with a plurality of sockets, in the sockets are formed retaining holes, and the independent terminals are provided with non-return flap in response to the sockets. With the help of the non-return flap and the retaining hole, the independent terminal can be quickly and easily fixed in the sockets of the connector. Thereby, the earphone connector of the present invention can be easily assembled and the cost is accordingly decreased.

### BACKGROUND OF THE INVENTION

1. Field of the Invention

The present invention relates to a connector, and more particularly to an earphone connector assembly.

2. Description of the Prior Arts

Referring to FIG. 1, which is a cross sectional view of a conventional earphone plug, a jack 11 is formed at an end of the connector 10. In the connector 10 are disposed two folded terminals 12. One of the folded terminals 12 has a folded movable end 121 which serves to actuate a switch 13. A conductive element 14 is disposed in the switch 13 and slides on the metal terminals 15a, 15b, and 15c of the connector 10 along with the movement of the switch 13.

Referring to FIG. 2, which is an operational view of a conventional earphone plug. When the user inserts an earphone plug 16 in the jack 11 of the connector 10, the earphone plug 16 will press the movable end 121 of the terminal 12, and the switch 13 will be caused to move. As a result, the conductive element 14 is caused to move, from the metal terminals 15a and 15b to the terminals 15b and 15c, along with the switch 13. At this moment, the metal terminals 15b and 15c is turned on according to the predetermined design of the circuit board, and then the sound signal is transmitted from the circuit board to the earphone plug 16 via the metal terminals 15b and 15c.

Once the user pulls the earphone plug 16 out of the jack 11 of the connector 10, the terminal 12 will push the switch 13 and the conductive element 14 back to their original position, thus disconnecting the connector.

It can be learned from the above-mentioned structure that the conventional earphone connector still has some defects which are to be explained as follows:

Since the earphone connector 10 is a small device, it is not easy to assemble independent terminal 12, the switch 13, the conductive member 14 and the metal terminals 15 in the connector 10 and fix them in place. In this cost, the assembling cost for the conventional earphone connector is high, and the assembling rate is accordingly slow.

The present invention has arisen to mitigate and/or obviate the afore-described disadvantages.

### SUMMARY OF THE INVENTION

The primary object of the present invention is to provide an earphone connector assembly which comprises: a connector, a cover and a plurality of independent terminals. The connector is provided with a plurality of sockets, in the sockets are formed a plurality of retaining holes, and the independent terminals are provided with non-return flap in response to the sockets. With the help of the non-return flap and the retaining hole, the independent terminal can be quickly and easily fixed in the sockets of the connector. Thereby, the earphone connector of the present invention can be easily assembled and the cost is accordingly decreased.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a cross sectional view of a conventional earphone connector assembly;

FIG. 2 is an operational view of a conventional earphone connector assembly;

FIG. 3 is an exploded view of an earphone connector assembly in accordance with the present invention;

FIG. 4 is an assembly view of an earphone connector assembly in accordance with the present invention;

FIG. 5 is an exploded view of the independent terminals of the earphone connector assembly in accordance with the present invention;

FIG. 6 is an assembly cross sectional view of the independent terminals of the earphone connector assembly in accordance with the present invention;

FIG. 7 is an operational cross-sectional view the earphone connector assembly in accordance with the present invention;

FIG. 8 is an exploded view of an earphone connector assembly in accordance with a second preferred embodiment of the present invention.

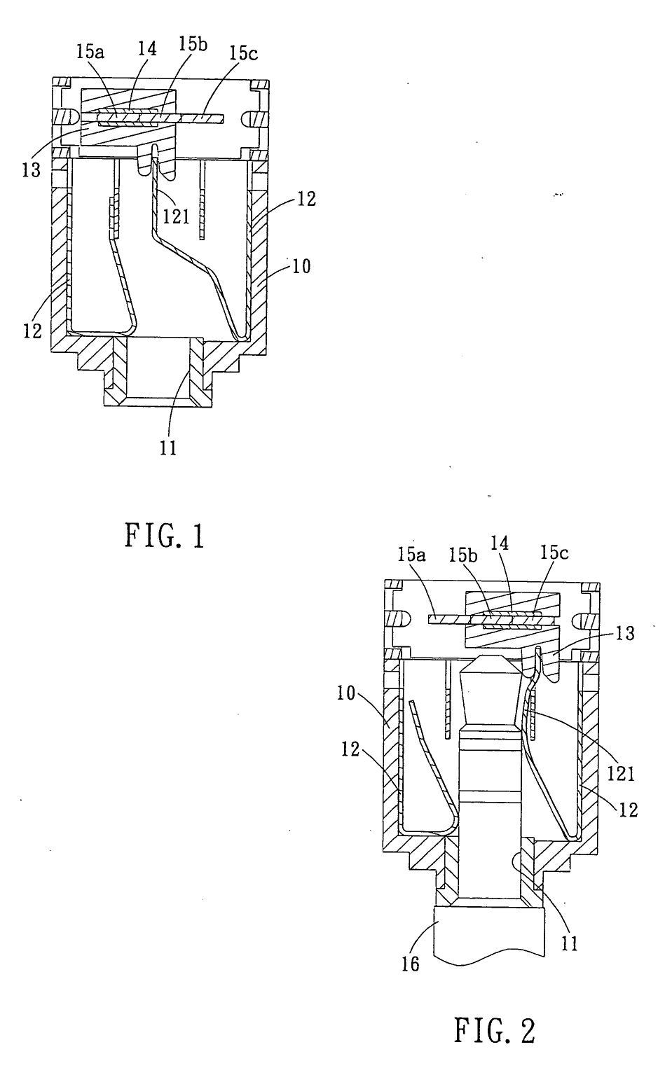

### DETAILED DESCRIPTION OF THE PREFERRED EMBODIMENTS

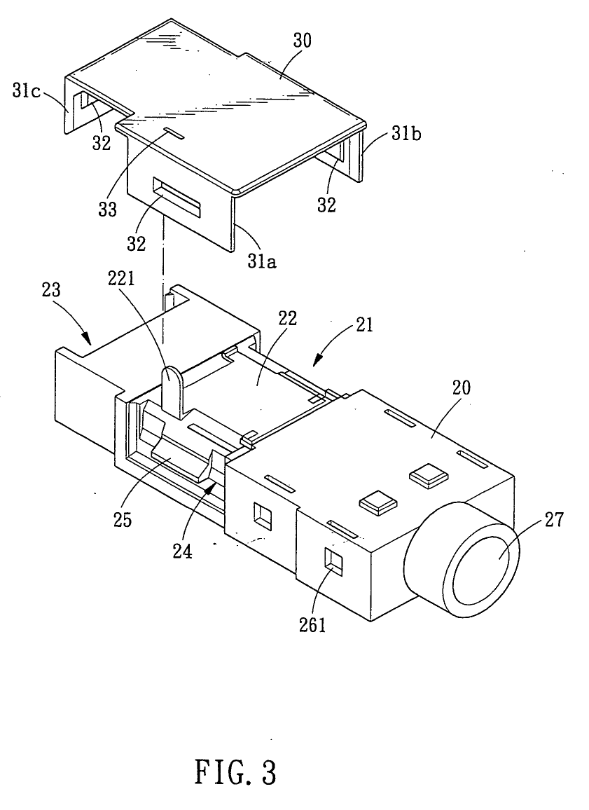

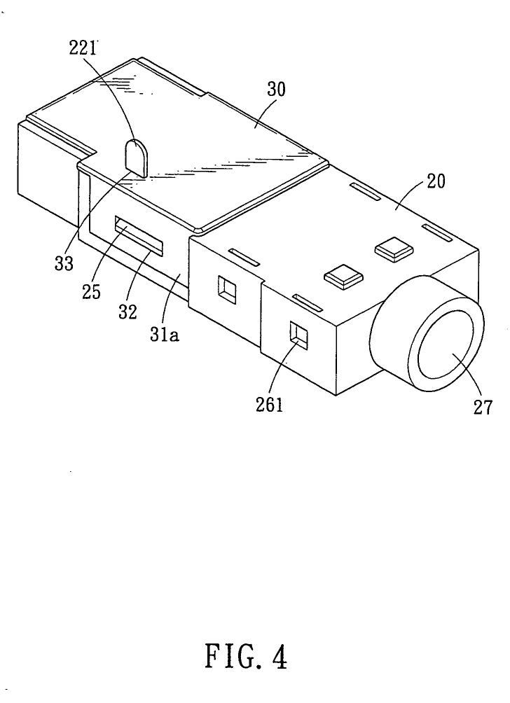

Referring to FIGS. 3-6, an earphone connector assembly in accordance with the present invention generally comprises: a connector 20, a cover 30 and a plurality of independent terminals 40.

The connector 20 is an integral member made of plastic material and formed with a “Π” shaped recess 21. In the “Π” shaped gap 21 is provided a metal terminal 22 which has a folded metal end 221, at a terminal end of the connector 20 is formed a gap 23. At both sides of the recess 21 is defined a concaved side 24 which is provided with a locking projection 25. In the gap 23 is also provided a locking projection 25. A plurality of sockets 26 are formed on the surface of the connector 20, and the opening direction of the sockets 26 is opposite to the installation direction of the connector 20. The sockets 26 correspond to the connecting elements inside the connector 20. On the sidewall of the connector 20 are formed a plurality of rectangular retaining holes 261 which are in communication with the sockets 26. A jack 27 is provided at another end of the connector 20, and the jack 7 is connected to the respective sockets 26 by a plurality of assembling holes 201, at another surface of the connector 20 are formed a plurality of through hole 202 which are in communication with the respective sockets 26.

The cover 30 is made of non-conductive plastic and used to engage the “Π” shaped recess 21, the cover 30 includes three folded arms 31a, 31b and 31c. Each of the folded arms 31a, 31b and 31 is formed with a locking hole 32. The folded arms 31a and 31b correspond to the two concaved sides 24 of the “Π” shaped recess 21, and the folded arm 31c corresponds to the gap 23 of the connector 20. When the cover 30 engages the “Π” shaped recess 21, the locking holes 32 on the respective folded arms 31a, 31b and 31c will be engaged with the respective locking projections 25, and the metal terminal 22 of the connector 20 will be fully covered by the cover 30. The cover 30 is formed with a through aperture 33 for allowing insertion of the metal end 221.

The independent terminals 40 are made of conductive material and each of which is a one-piece folded member. A “U”-shaped portion 41 of the independent terminal 40 is used to produce a predetermined elastic force. A first end of the independent terminals 40 is a contacting end 42 and at a second end of the independent terminals 40 is formed a locking block 43. A non-return flap 44 is provided on each of the independent terminals 40 and located adjacent to the U-shaped portion 41. The independent terminals 40 are inserted in the respective sockets 26 in a such a manner that the contacting end 42 projects out the through hole 202, the locking block 43 partially projects out the assembling hole 201, and the non-return flap 44 engages the retaining hole 261 on the sidewall of the sockets 26. The independent terminals 40 can contact the connecting elements inside the connector 20. One of the independent terminals 40 is provided at another end opposite to the contacting end 42 with a folded moveable end 45, at the terminal end of the folded moveable end 45 is formed a conductive portion 451.

The cover 30 is a non-conductive member whose three locking holes 32 on the three folded arms 31a, 31b and 31c can be engaged with the locking projections 25 of the connector, and the cover 30 accordingly fully covers the metal terminal 22 of the connector 20, thus protecting the metal terminal 22 from being influenced by turpentine and the high temperature of the Tin stove. As a result, the turpentine will not infiltrate into the metal terminal 22 and cause the bad contact of the earphone.

On the other hand, the cover 30 is provided with through apertures 33 which are provided for insertion of the metal ends 221, thus, the metal ends 221 can be stably fixed in the through apertures 33 without being deformed.

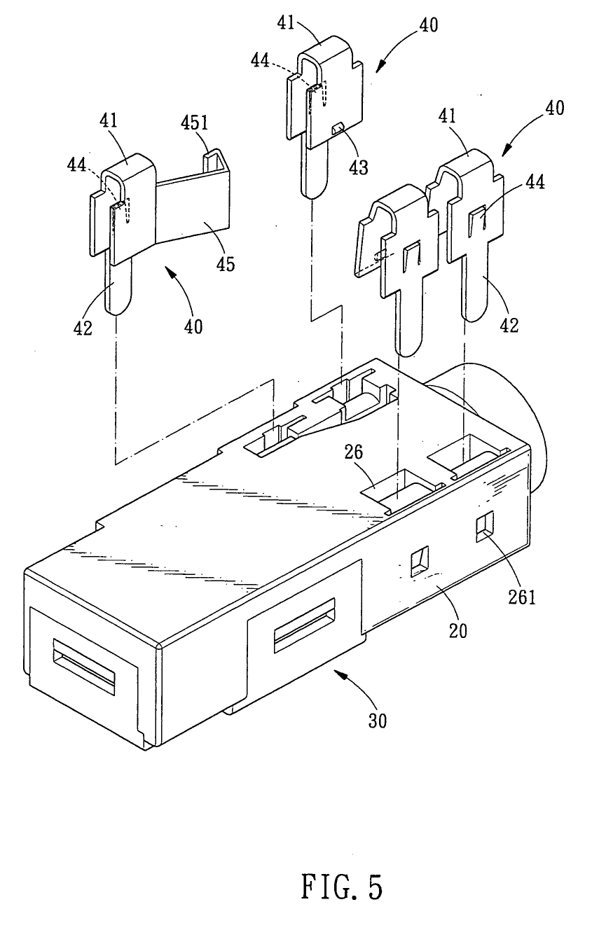

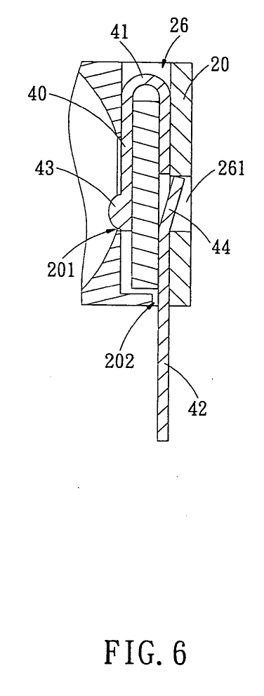

Referring to FIGS. 5 and 6, to assemble the independent terminal 40, the independent terminal 40 should be inserted in the sockets 26 of the connector 20, so that the contacting end 42 projects out of the assembling hole 201, the locking block 43 partially projects out of the assembling hole 201, and the non-return flap 44 engages the retaining hole 261 on the sidewall of the sockets 26. With the help of the non-return flap 44 and the retaining hole 261, the independent terminal 40 can be quickly and easily fixed in the sockets 26 of the connector 20. Thereby, the earphone connector of the present invention can be easily assembled and the cost is accordingly decreased.

Since the non-return flap 44 is integral with and projects out of the independent terminals 40, the non-return flap 44 can be pressed down by the inner sidewall of the sockets 26, so as to allow the independent terminal 40 to insert in the sockets 26 easily, and the non-return flap 44 will project out of the retaining hole 261 once it reaches the retaining hole 261. Thereby, the independent terminals 40 can be fixed firmly in the sockets 26 of the connector 20.

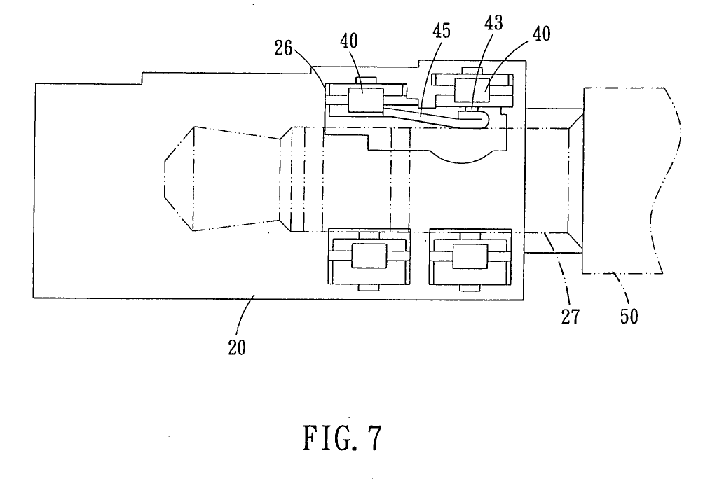

Referring to FIGS. 5 and 7, once the earphone plug 50 inserts in the jack 27 of the connector 20, the moveable end 45 of the independent terminal 40 will be pushed away by the earphone plug 50, the conductive portion 451 of the moveable end 45 of the independent terminal 40 will contact the locking block 43 of another independent terminal 40. At this moment, the independent terminal 40 is turned on according to the predetermined design of the circuit board, and then the sound signal is transmitted from the circuit board to the earphone plug 50 via the metal end 221 (the metal end 221 is not shown in FIGS. 5 and 7 but in FIG. 6). The independent terminal 40 is turned on when its conductive portion 451 of the moveable end 45 contacts the locking block 43 of another independent terminal 40, thus creating a contact switch.

When the user pulls the earphone plug 50 out from the jack 27 of the connector 20, the moveable end 45 will be returned to its original position automatically by its own elastic force, and the conductive portion 451 of the moveable end 45 of the independent terminal 40 will not contact the locking block 43 of another independent terminal 40, thus turning off the independent terminal 40.

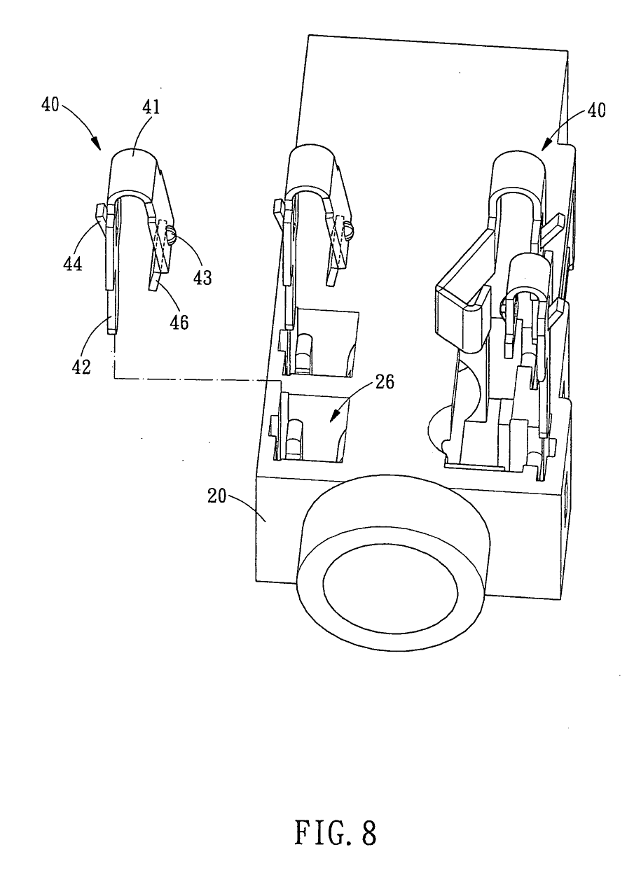

Referring to FIG. 8, an earphone connector assembly in accordance with a second preferred embodiment also comprises a connector 20, a cover 30 and a plurality of independent terminals 40. The structural relationship of these components of the second embodiment is the same as that of the first embodiment, thus, only the differences are to be explained as follows:

The end of the independent terminals 40 having the locking block 43 is further provided with a folded portion 46 which can enable the independent terminals 40 to be firmly engaged in the sockets 26 of the connector 20. The function of the second embodiment is also identical to the first embodiment, so further explanations will be omitted.

While we have shown and described various embodiments in accordance with the present invention, it should be clear to those skilled in the art that further embodiments may be made without departing from the scope of the present invention.

What is claimed is:

1. An earphone connector assembly comprising:
an integral-formed connector made of plastic and formed with a “Π” shaped recess and a jack, in the “Π” shaped gap provided a metal terminal, the metal terminal having a folded metal end, at an end of the connector formed a gap, in two concaved sides of the “Π” shaped recess and in the gap provided a locking projection, respectively, a plurality of sockets formed on the connector, the sockets correspond to connecting elements inside the connector, at another surface of the connector are formed a plurality of through hole, the jack is connected to the sockets by a plurality of assembling holes, on the connector formed a plurality of retaining holes which are in communication with the sockets;
a cover made of non-conductive material and comprising three folded arms used to insert in the “Π” shaped recess and two concaved sides of the connector, each of the folded arms formed with a locking hole which are employed to be engaged with the respective locking projections, and the metal terminal of the connector fully covered by the cover, the cover formed with a through aperture for allowing insertion of the metal end;
a plurality of independent terminals made of conductive material and each of which is a one-piece folded member, wherein a first end of each of the independent terminals is a contacting end and a non-return flap is provided on each of the independent terminals adjacent to a bent portion, the independent terminals are inserted in the respective sockets in a such a manner that the contacting end projects out the through hole of the connector, a second end of the independent terminals opposite to the contacting end partially projects out the assembling hole, and the non-return flap engages the respective retaining holes, one of the independent terminals is provided at the second end opposite to the contacting end with a folded moveable end which will be pushed by an earphone plug, when the earphone inserts in the jack of the connector, to contact and turn on another independent terminal.

2. The earphone connector assembly as claimed in claim 1, wherein a locking block is provided at the second end of the independent terminals and-used to insert in the respective sockets of the connector.

3. The earphone connector assembly as claimed in claim 1, wherein a folded portion is provided at the second end of the independent terminals and used to insert in the respective sockets of the connector.

4. The earphone connector assembly as claimed in claim 1, wherein a conductive portion is provided at the folded moveable end and used to contact and turn on another independent terminal once the earphone plug inserts in the jack.
